(19) United States
(12) Patent Application Publication
(10) Pub. No.: US 2007/0158583 A1
(43) Pub. Date: Jul. 12, 2007

(54) Disk assembly of ion implanter

(76) Inventor: Yeon-Ha Cho, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/649,791

(22) Filed: Jan. 5, 2007

(30) Foreign Application Priority Data
Jan. 11, 2006 (KR) 10-2006-0003174

(51) Int. Cl. G21K 5/10

(52) U.S. Cl. 250/440.11; 250/492.21

(57) ABSTRACT

A disk assembly of an ion implanter includes a disk rotating in one direction, at least one wafer site on the disk for holding a wafer, at least one fence positioned outside an outer edge of the at least one wafer site and perpendicularly to the disk, a finger positioned outside the outer edge of the at least one wafer site and opposite the fence, at least one sensor having the capability of determining a position of the wafer relative to the fence, and a control unit electrically connected to the at least one sensor.

### BACKGROUND OF THE INVENTION

1. Field of the Invention

The present invention relates to a disk assembly of an ion implanter. In particular, the present invention relates to a disk assembly of a batch-type ion implanter having an improved structure for securing a plurality of wafers therein.

2. Description of the Related Art

The rapid development of technologies in the fields of information and communication has triggered enhanced manufacturing growth of computers and semiconductor systems, thereby providing increased demand for semiconductor devices having high integration density, i.e., semiconductor devices having reduced size and maximized performance. Technologies providing such semiconductor devices may include thermal diffusion technology and ion implantation technology, i.e., implantation of conductive impurities into a silicon substrate, e.g., CMOS, while ion implantation technology may provide implantation of impurities at lower concentration and through insulating layers, as opposed to thermal diffusion technology.

A conventional ion implanter may include a terminal module to select and ionize a conductive impurity to be implanted into a wafer, an accelerator to accelerate the impurity ions, and an end station module to implant the accelerated impurity ions into a surface of the wafer in a vacuum environment to provide sufficient implantation depth.

A conventional end station module of an ion implanter may include a process chamber, a transfer chamber and a load lock chamber, where a plurality of wafers may be moved from one chamber to another in a vacuum environment. The conventional end station module may also include a scanner to scan the ion beam formed in the accelerator and a disk assembly to rotate the wafers at a predetermined high speed during ion implantation. The conventional disk assembly may include a disk to hold wafers, a lift assembly to transfer wafers to/from the disk, and a fence to secure the wafers in the disk assembly.

However, in the conventional disk assembly of an ion implantation system the wafers loaded into the disk assembly may not be sufficiently secured by the fence at their outer edges. Accordingly, the wafers in the conventional disk assembly may move during rotation thereof, thereby triggering improper ion implantation therein. Movement of wafers may also cause collisions thereof with the fence or imbalance the disk assembly and cause vibrations. Such process flaws may increase the potential for implantations defects and wafer damage, thereby reducing quality and throughput thereof.

Accordingly, there exists a need for a disk assembly of an ion implanter having an improved structure for securing a plurality of wafers therein.

### SUMMARY OF THE INVENTION

The present invention is therefore directed to a disk assembly of an ion implanter, which substantially overcomes one or more of the problems due to the limitations and disadvantages of the related art.

It is therefore a feature of an embodiment of the present invention to provide a disk assembly of an ion implanter having a structure with improved wafer securing means capable of minimizing wafer movement placed thereon.

At least one of the above and other features and advantages of the present invention may be realized by providing a disk assembly of an ion implanter, including a disk rotating in one direction, at least one wafer site positioned on the disk and capable of holding at least one wafer, at least one fence positioned at an edge of the at least one wafer site, a finger positioned at the edge of the at least one wafer site and opposite the fence, at least one sensor having the capability of determining a position of the wafer relative to the fence, and a control unit electrically connected to the at least one sensor.

The wafer site may include a pad to support the wafer. The wafer site may also include a plurality of lift pin holes, at least one sliding pin hole, and a sensor hole.

The disk assembly may further include a plurality of sliding fences adjacent to the finger. At least one sliding fence of the plurality of sliding fences may be positioned at each side of the finger along an outer edge of the wafer site. Each sliding fence of the plurality of sliding fences may have a beveled side wall. The fence and the plurality of sliding fences may form a shape having a diameter about equal to a diameter of the wafer.

The at least one sensor may be a WAP sensor positioned in a center of the wafer site, wherein the WAP sensor may include a capacitance sensor or a switch sensor. Alternatively, the at least one sensor may be a secured wafer verifying sensor formed in the fence, wherein the wafer verifying sensor may include a switch sensor. The at least one sensor may include a plurality of wafer verifying sensors positioned symmetrically in the fence relative to a center of the fence.

In another aspect of the present invention, there is provided a method of loading a wafer into a disk assembly of an ion implanter, including placing a wafer onto a wafer site, securing the wafer on the wafer site against a fence, operating a sensor to determine a position of the wafer relative to the fence, transmitting a signal to a controller to indicate the position of the wafer relative to the fence, and controlling the ion implanter in response to the signal transmitted to the controller.

Placing the wafer onto the wafer site may include sliding the wafer onto the wafer site via at least one sliding fence. Securing the wafer against the fence may include moving a finger positioned at the wafer site opposite the fence in a horizontal direction towards the fence.

Operating a sensor may include determining a distance between the wafer and the fence. Alternatively, operating a sensor may include determining a presence of a contact between the wafer and the fence.

Controlling the ion implanter may include generating an interlock signal to terminate ion implantation, when the wafer is not secured against the fence. Additionally, controlling the ion implanter may include generating a control signal to indicate a loading failure for an operator. Controlling the ion implanter may include generating a control signal to the finger to secure the wafer against the fence prior to generating an interlock, when the wafer is not secured against the fence.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial plan view of a disk assembly of an ion implanter according to an exemplary embodiment of the present invention;

FIG. 2 illustrates a schematic side view of the disk assembly illustrated in FIG. 1;

FIG. 3 illustrates a partial perspective view of a wafer site of a disk assembly of an ion implanter according to an exemplary embodiment of the present invention;

FIG. 4 illustrates a partial cross-sectional view of the wafer site illustrated in FIG. 3;

FIG. 5 illustrates a partial plan view of a disk assembly of an ion implanter according to another exemplary embodiment of the present invention;

FIG. 6 illustrates a schematic side view of the disk assembly illustrated in FIG. 5;

FIG. 7 illustrates a partial perspective view of a wafer site of a disk assembly of an ion implanter according to another exemplary embodiment of the present invention;

FIG. 8 illustrates a partial cross-sectional view of the wafer site illustrated in FIG. 7;

FIG. 9 illustrates a flow chart of a method of loading a wafer into a disk assembly according to an exemplary embodiment of the present invention; and

FIG. 10 illustrates a flow chart of a method of loading a wafer into a disk assembly according to another exemplary embodiment of the present invention.

### DETAILED DESCRIPTION OF THE PRESENT INVENTION

Korean Patent Application No. 10-2006-0003174, filed on Jan. 11, 2006, in the Korean Intellectual Property Office, and entitled: “Disk Assembly of Ion Implanter,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

It will further be understood that when an element is referred to as being “on” another element or substrate, it can be directly on the other element or substrate, or intervening elements may also be present. Further, it will be understood that when an element is referred to as being “under” another element, it can be directly under, or one or more intervening elements may also be present. In addition, it will also be understood that when an element is referred to as being “between” two elements, it can be the only element between the two elements, or one or more intervening elements may also be present. In contrast, when an element is referred to as being “directly on,” there may be no intervening elements or layers present. Like reference numerals refer to like elements throughout.

As used herein, the term “and/or” may include any and all combinations of one or more of the associated listed items.

As further used herein, the singular forms “a,” “an” and “the” are intended to include the plural forms as well, unless the context clearly indicates otherwise.

Unless otherwise defined, all terminology used herein is given its ordinary meaning in the art, and therefore, should be interpreted within the context of the specification and the relevant art as understood by one of ordinary skill.

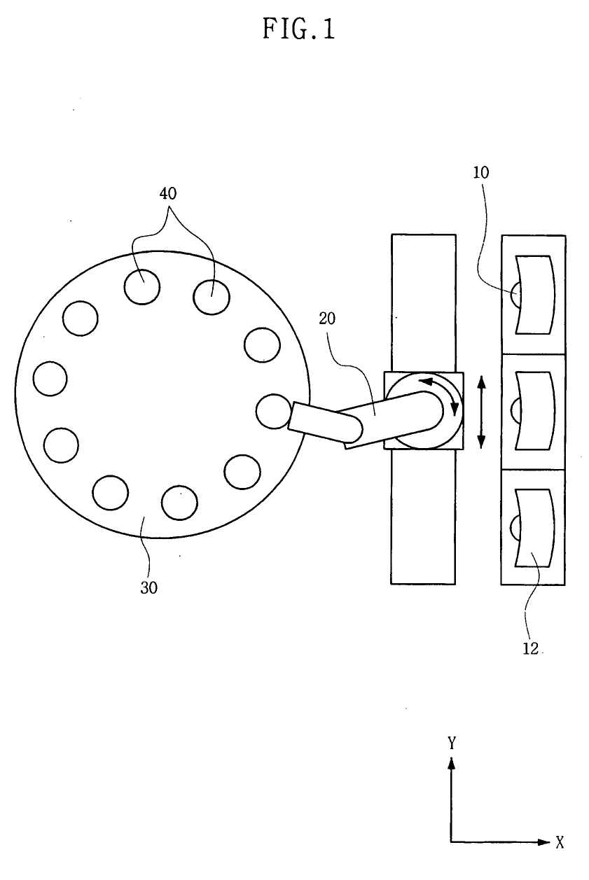

An exemplary embodiment of the present invention will now be more fully described with respect to FIGS. 1-4, which illustrate an embodiment of a disk assembly of an ion implanter.

As illustrated in FIGS. 1-4, a disk assembly of an ion implanter according to an embodiment of the present invention may include a disk 30, at least one wafer site 40, at least one fence 42, at least one finger 44, a plurality of sliding fences 46, a wireless application protocol (WAP) sensor 50, and a control unit 70.

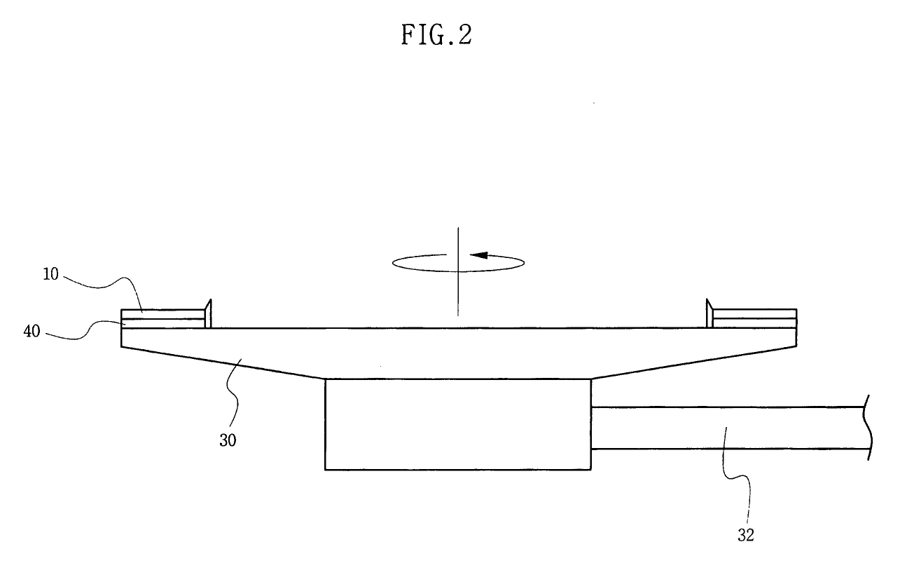

The disk 30 of the disk assembly according to an embodiment of the present invention may be formed in any convenient shape as determined by one of ordinary skill in the art to rotate around its axis. The disk 30 may have a size sufficient to hold at least one wafer 10 and, preferably, a plurality of wafers 10, e.g., about eight to thirteen wafers 10. The disk 30 may be supported by a frame 32, as illustrated in FIG. 2, that is capable of vertical movement to provide horizontal loading of wafers 10 by a robotic arm 20 and horizontal ion implantation thereon. Accordingly, the at least one wafer 10 may be placed onto the disk 30 by the robotic arm 20, which may be capable of moving, rotating and extending in order to transfer wafers 10, as illustrated in FIG. 1.

The disk 30 may include a rotation power transfer unit (not shown) having a spindle and a gear in order to transfer a rotation power from an outside rotary body, e.g., a motor, to a central axis of the disk 30 and the frame 32 to facilitate rotation thereof, e.g., high speed of about 1200 rpm to about 2000 rpm, in order to intercept an ion implantation beam. More specifically, the disk 30 may rotate around its axis in one direction, while the ion implantation beam may be configured perpendicularly to a plane of a surface of the disk 30 and the surfaces of the wafers 10 positioned thereon and move vertically along a diameter of the wafer 10. Accordingly, the wafer 10 may intercept the moving ion implantation beam and, thereby, absorb impurities in horizontal and vertical directions, such that an entire surface of the wafer 10 may be treated with the ion implantation beam. For example, upon rotation of the disk 30 in a xy-plane around a z-axis, the ion implantation beam may move vertically, i.e., along the y-axis, such that impurities may be implanted on the xy-plane of the wafer 10 and along the vertical direction, i.e., y-axis, of the disk 30. Accordingly, since each wafer 10 may be treated with the ion implantation beam in two directions, i.e., horizontal and vertical, a complete surface coverage and efficient ion implantation may be provided for each wafer 10.

The at least one wafer site 40 of the disk assembly according to an embodiment of the present invention may be formed on the disk 30 for holding a wafer 10. Preferably, a plurality of wafer sites 40 may be formed on the disk 30 in close proximity to an edge of the disk 30, e.g., arranged on the disk 30 along a perimeter thereof, as illustrated in FIG. 1. The wafer sites 40 may be formed integrally to the disk 30 and be set apart from one another at an angle of 45 degrees with respect to a center of the disk 30.

The at least one wafer site 40 may include a pad 48. The pad 48 may be made of a silicon rubber material having a predetermined frictional coefficient. Additionally, the pad 48 may have a size, i.e., a surface area in contact with the wafer 10, that is equal to or less than that of the wafer 10 to provide support and a predetermined amount of voltage, e.g., outside voltage source, thereto. Without intending to be bound by theory, it is believed that the wafer site 40 with the pad 48 may have sufficient conductivity to absorb and ground an electric charge of the conductive impurities that are ion-implanted into the wafer 10 during the ion implantation process.

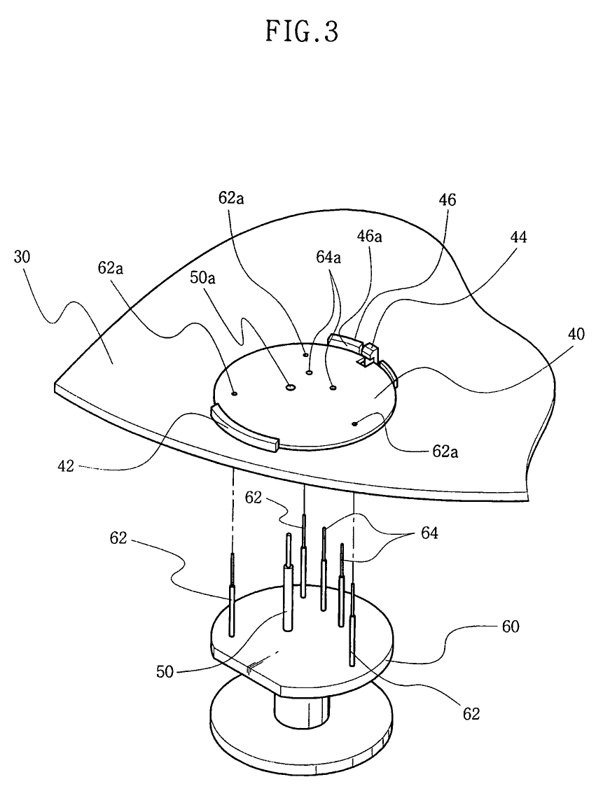

The wafer site 40 may also include a plurality of lift pin holes 62a, at least one or more sliding pin holes 64a, and a sensor hole 50a, as illustrated in FIG. 3 and will be discussed in more details below.

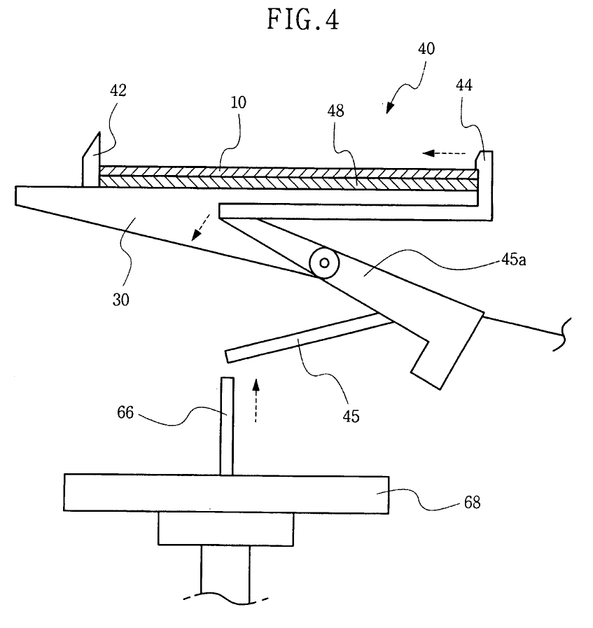

The at least one fence 42 of the disk assembly according to an embodiment of the present invention may be positioned on the disk 30 at an outer edge of the at least one wafer site 40. For example, the fence 42 may be formed integrally with the wafer site 40 and have a predetermined height that is larger than a height of the wafer site 40, such that the fence 42 may enclose and support an edge of the wafer 10 placed in the wafer site 40. The fence 42 may be positioned perpendicularly to an upper surface of the disk 30 between the wafer site 40 and the edge of the disk 30, as illustrated in FIG. 4, such that the fence 42 may be in close proximity to an edge of the disk 30 and prevent radial movement of the wafer 10 from the wafer site 40 upon rotation of the disk 30. The disk assembly according to an embodiment of the present invention may include a plurality of fences 42.

The at least one finger 44 of the disk assembly according to an embodiment of the present invention may be positioned on the disk 30 at an edge of the at least one wafer site 40. In particular, the finger 44 may be positioned between a center of the wafer site 40 and a center of the disk 30. More specifically, the finger 44 may be positioned directly across from a center of the fence 42, such that the center of the wafer site 40 may be located on a line connecting the center of the fence 42 and the finger 44. As such, the finger 44 may secure the wafer 10 on the wafer site 40 against the fence 42. For example, the finger 44 may have a predetermined height that is larger than a height of the wafer site 40 and be shaped as a hook or a clamp to facilitate securing of the wafer 10.

The sliding fences 46 of the disk assembly according to an embodiment of the present invention may be positioned adjacent to the finger 44. In particular, one sliding fence 46 may be positioned at each side of the finger 44 along an outer edge of the wafer site 40, as illustrated in FIG. 3, in order to secure an outer edge of the wafer 10 against the fence 42, i.e., secure an accurate position of the wafer 10 on the wafer site 40. In other words, the sliding fences 46 may be positioned outside the wafer site 40 along a perimeter thereof and opposite the fence 42, such that a distance between an inner edge of the sliding fences 46 and an inner edge of the fence 42 may equal to a diameter of the wafer 10.

The sliding fences 46 may be formed to be higher than the wafer site 40. Additionally, the sliding fences 46 may include bevelled side walls 46a. In particular, one side wall 46a of each of the sliding fences 46 may be positioned to form a predetermined angle with the plane of the wafer site 40, such that the wafer 10 may slide down the bevelled side walls 46a of the sliding fences 46 into the wafer site 40. More specifically, the bevelled side wall 46a of each sliding fence 46 may be positioned in close proximity to the wafer site 40 and along the outer perimeter thereof to facilitate the formation of the predetermined angel between the wafer site 40 and the vebelled side wall 46a. The bevelled side walls 46a of the sliding fences 46 may be related to a frictional coefficient of the pad 48 to secure the wafer 10 against the fence 42, upon sliding of the wafer 10 into the wafer site 40. For example, the robotic arm 20 may place the wafer 10 into the wafer site 40 of the disk assembly, such that the wafer 10 may slide from the sliding fences 46 to the wafer site 40 to be positioned about 2 mm off an edge of the fence 42 along a line connecting the center of the fence 42 and the center of the wafer site 40.

The WAP sensor 50 of the disk assembly according to an embodiment of the present invention may be employed to determine whether the wafer 10 is secured against the fence 42 on the wafer site 40 by the finger 44. The WAP sensor 50 may be a non-touch sensor capable of determining whether the wafer 10 having a size defined by the fence 42 and the sliding fences 46 overlaps with the pad 48 of the wafer site 40. In particular, the WAP sensor 50 may include a capacitance sensor for measuring the capacitance between the wafer 10 and the pad 48 to determine contact therebetween.

For example, the capacitance sensor of the WAP sensor 50 may include a capacitance probe (not shown) inserted through the sensor hole 50A, such that an upper tip of the probe may be at the same height, i.e., vertical distance with respect to the plane of the disk 30, as the height of the pad 48 to facilitate measurement of capacitance with respect to the distance between the wafer 10 and the probe. More specifically, a large distance between the capacitance probe of the capacitance sensor and the wafer 10 may provide low capacitance measurements, while a short distance may provide high capacitance measurements. Accordingly, a numerical difference between capacitance measurements may provide a determination by the control unit 70 whether the wafer 10 overlaps with the pad 48. Overlap of the wafer 10 with the pad 48 may indicate that the wafer 10 is secured against the fence 42.

In another example, the capacitance sensor of the WAP sensor 50 may include an electrical probe (not shown) for grounding electrostatic charge applied to the pad 48 in order to measure capacitance with respect to the electrical current and distance between the wafer 10 and the pad 48. More specifically, a very large distance between the pad 48 and the wafer 10 may provide very low capacitance and negligible measurements thereof, a small distance may provide high capacitance measurements, while no distance, i.e., contact between the pad 48 and the wafer 10, may provide zero capacitance. Accordingly, a numerical difference between capacitance measurements may provide a determination by the control unit 70 whether the wafer 10 is in physical contact with the pad 48 and is thereby secured against the fence 42.

Alternatively, the WAP sensor 50 may be a touch sensor, and it may include a switch sensor capable of employing a weight of the wafer 10 to determine whether the wafer 10 is positioned at a horizontal position overlapping with the pad 48.

The disk assembly according to an embodiment of the present invention may further include at least one lift body 60. The at least one lift body 60 may be positioned under the disk 30 adjacent to the robotic arm 20 to facilitate movement thereof. Alternatively, a plurality of lift bodies 60 may be employed, such that each lift body 60 may be positioned under a respective wafer site 40. Each lift body 60 may include a plurality of lift pins 62, a plurality of sliding pins 64 and a finger actuator 66 on a lift assembly 68. Additionally, the WAP sensor 50 may be positioned on the lift body 60.

The lift pins 62, the sliding pins 64, and the WAP sensor 50 may be positioned perpendicularly to a plane of the lift body 60. Additionally, the lift pins 62, the sliding pins 64, and the WAP sensor 50 may be positioned to correspond in terms of number and geometrical configuration to the lift pin holes 62a, sliding pin holes 64a, and sensor hole 50a, respectively, of a respective wafer site 40. Accordingly, the lift assembly 68 of the lift body 60 may independently lift the lift pins 62, the sliding pins 64, and the WAP sensor 50 upwards. In particular, the plurality of lift pins 62 may protrude through respective lift pin holes 62a to position the wafer 10 transferred by the robotic arm 20 onto the pad 48 or raise the wafer 10 above the wafer site 40 to facilitate removal thereof after completion of the ion implantation process. Similarly, the plurality of sliding pins 64 may protrude through the sliding pin holes 64a to raise one side of the wafer 10, i.e., a side of the wafer 10 adjacent to the finger 44, and thereby tilt the wafer 10 held on the pad 48 toward the fence 42 and secure it against the fence 42 using the finger 44 or the sliding fence 46. The WAP sensor 50 may protrude through the sensor hole 50a formed in a center of the wafer site 40 to determine positioning of the wafer 10 as discussed previously.

The finger actuator 66 formed on the lift assembly 68 of the lift body 60 may be positioned perpendicularly to a plane of the lift assembly 68, as illustrated in FIG. 4. The finger actuator 66 may be moved vertically by the lift assembly 68 and support a pull rod 45. The pull rod 45 may rotate and transfer its rotation power to the finger 44 via a pull rod connection unit 45a. The rotational motion of the pull rod 45 may be translated into a linear motion, thereby providing horizontal movement to the finger 44, as illustrated in FIG. 4. The horizontal movement of the finger 44 may secure the wafer 10 against the fence 42, as further illustrated in FIG. 4, by a predetermined press power generated by the rotation of the disk 30. Accordingly, without intending to be bound by theory, it is believed that the finger 44 may secure the wafer 10 against the fence 42 after disconnecting the finger actuator 66 from the pull rod 45 due to a restitution force of the pull rod 45. Therefore, as the disk 30 rotates, the finger 44 may secure one edge of the wafer 10 to the wafer site 40 with a predetermined adsorption, while the fence 42 may secure an opposite edge of the wafer 10 to the wafer site 40.

The control unit 70 of the disk assembly according to an embodiment of the present invention may determine whether the wafer 10 is secured against the fence 42. The control unit 70 may be electrically connected to the WAP sensor 50 and receive signals therefrom. In particular, if the wafer 10 is not secured against the fence 42 and/or does not have a proper contact with the wafer site 40 as determined by the WAP sensor 50, an appropriate signal may be transmitted to the control unit 70. In response, the control unit 70 may output an interlock control signal to pause the rotation of the disk 30, thereby pausing the overall ion implantation process. The interlock signal may prevent the wafer 10 from colliding with the fence 42 due to the rotation of the disk 30, thereby increasing the production yield of the wafers 10.

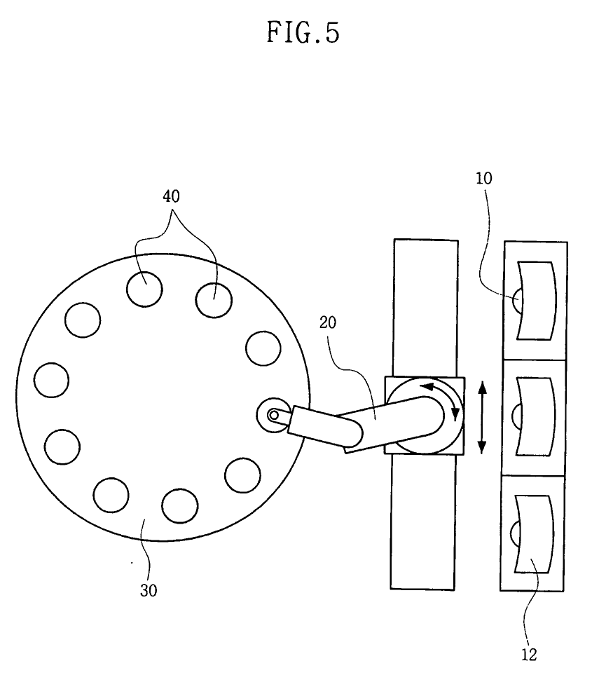

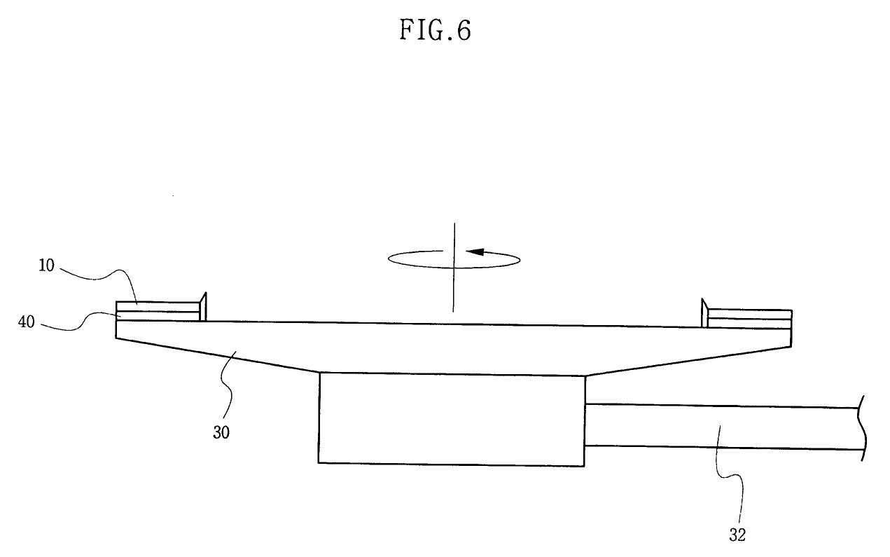

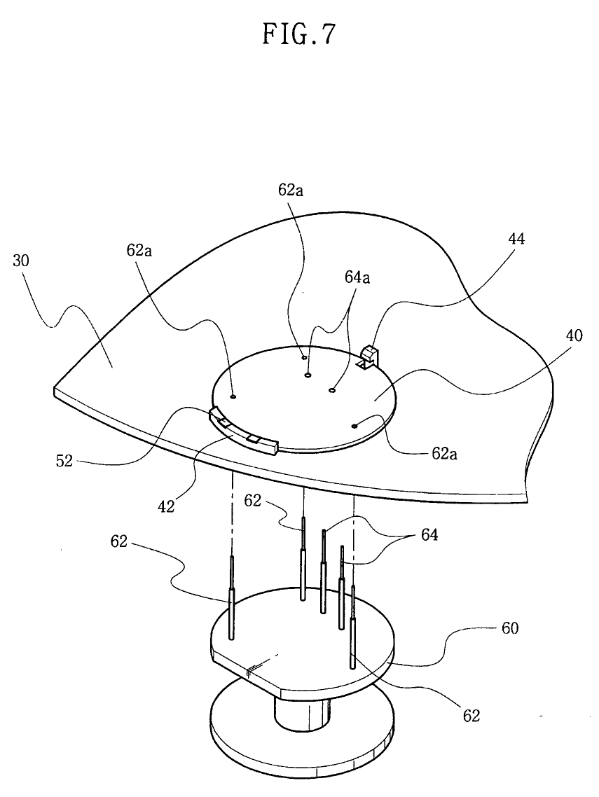

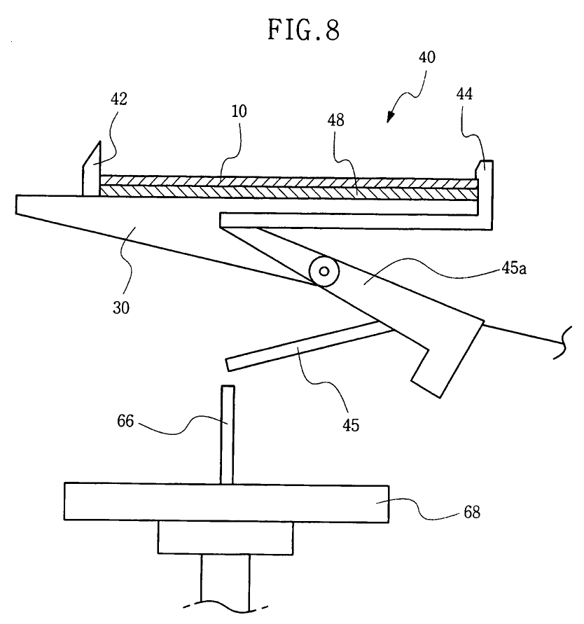

In another embodiment of the present invention illustrated in FIGS. 5-8, the disk assembly of the ion implanter may include a disk 30, at least one wafer site 40, at least one fence 42, at least one finger 44, at least one secured wafer verifying sensor 52 to determine whether the wafer 10 is properly secured against the fence 42, and a controller unit 70 electrically connected to the secured wafer verifying sensor 52.

It is noted that the particular elements included in the embodiment illustrated in FIGS. 5-8 are similar to the description provided previously with respect to the disk assembly illustrated in FIGS. 1-4. Accordingly, only details that may be distinguishable from the previous embodiment will be described hereinafter. Details and descriptions that may be found in both embodiments of the wafer transfer apparatus illustrated in FIGS. 1-8 will not be repeated herein.

The at least one secured wafer verifying sensor 52 according to an embodiment of the present invention may be any known sensor in the art that is capable of determining contact and/or distance between elements, e.g., touch sensor, as may be determined by one of ordinary skill in the art. The at least one secured wafer verifying sensor 52 may be formed in a side wall of the fence 42 to verify correct securing and positioning of the wafer 10 against the fence 42 by the finger 44. In particular, the secured wafer verifying sensor 52 may be positioned in a center of the side wall of the fence 42 that is facing the wafer site 40, such that the secured wafer verifying sensor 52 may be on an extension of a straight line connecting the finger 44 and the center of the wafer site 40. If two secured wafer verifying sensors 52 are employed in the disk assembly according to an embodiment of the present invention, they may be positioned symmetrically in the side wall of the fence 42 that is facing the wafer site 40, i.e., one secured wafer verifying sensor 52 may be positioned on each side of the fence along the side wall of the fence 42 that is facing the wafer site 40, such that the extension of the straight line connecting the finger 44 and the center of the wafer site 40 may pass therebetween.

The secured wafer verifying sensor 52 may include a touch sensor (not shown) having a switch sensor, e.g., a micro switch, a limit switch, and so forth, capable of determining a contact between the fence 42 and the wafer 10, upon correct securing of the wafer 10. In particular, when the wafer 10 is correctly placed on the wafer site 40 and sufficiently secured against the fence 42 with the finger 44, the wafer 10 may touch a lever, thereby activating the secured wafer verifying sensor 52 to indicate to the control unit 70 a contact between the fence 42 and the wafer 10. When a plurality of secured wafer verifying sensors 52 is employed, each one of the secured wafer verifying sensors 52 may independently determine and transmit a signal to the control unit 70 indicating whether contact between the fence 42 and the wafer 10 exists.

For example, if the control unit 70 receives a signal from at least one of the secured wafer verifying sensors 52 that a contact does not exist between the fence 42 and the wafer 10, the control unit 70 may determine that the wafer 10 is not accurately secured against the fence 42. Accordingly, the control unit 70 may output a control signal to the finger 44 for securing the wafer 10 against the fence 42. Alternatively, the control unit 70 may output an interlock control signal to pause the overall ion implantation process due to a failure in the wafer loading process.

If the control unit 70 receives a signal from all the secured wafer verifying sensors 52 that a contact exists between the fence 42 and the wafer 10, the control unit 70 may determine that the wafer 10 is accurately secured against the fence 42. Accordingly, the control unit 70 may output a control signal to continue the overall ion implantation process. Such operation of the at least one secured wafer verifying sensor 52 and control unit 70 may prevent improper loading of wafers into the disk assembly, thereby maximizing quality and production yield thereof.

The disk assembly according to an embodiment of the present invention may further include sliding fences 46 to secure the wafer 10 against the fence 42 as previously described with reference to the embodiment illustrated in FIGS. 1-4. However, the scope of the embodiment described with respect FIGS. 5-8 is not limited to a structure having the sliding fences 46.

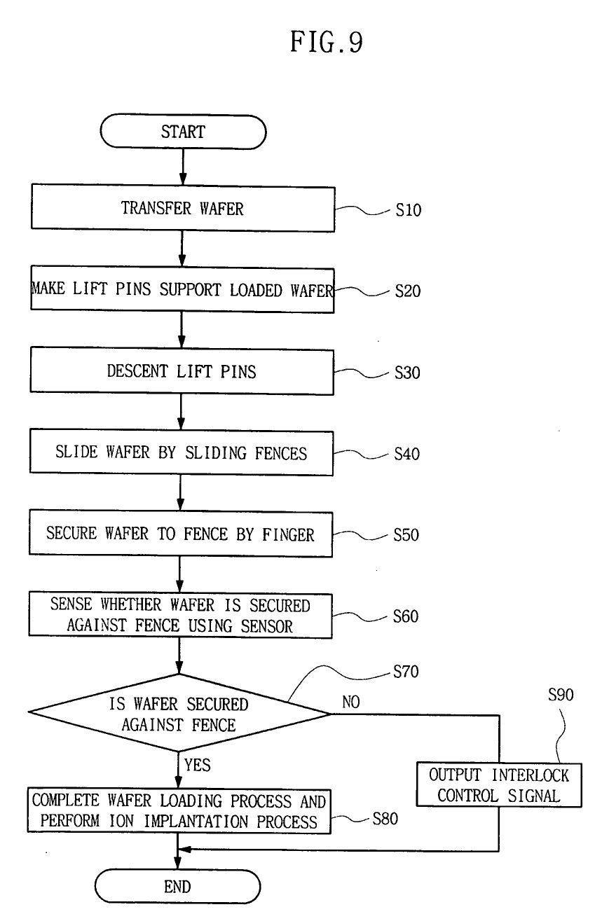

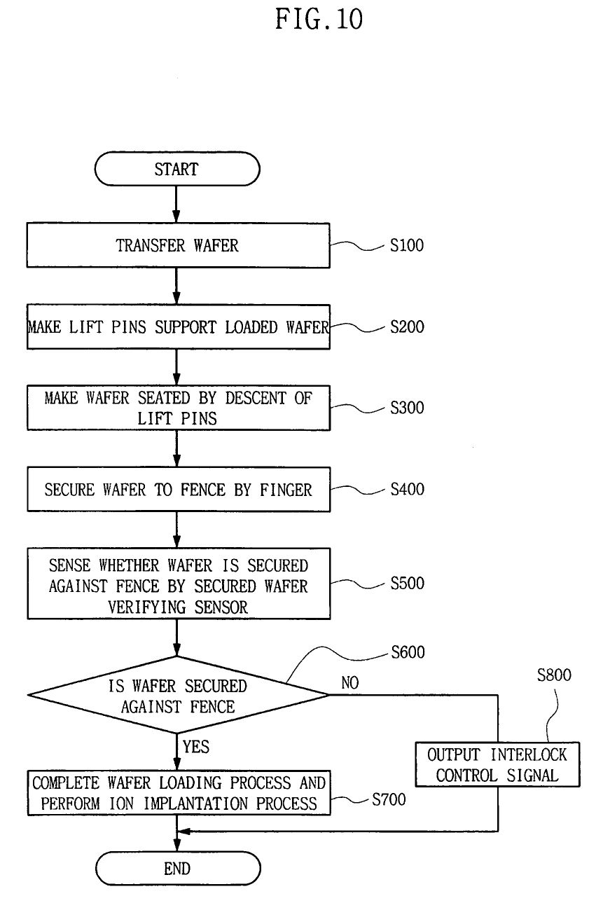

In accordance with another embodiment of the present invention, a method for loading wafers into a disk assembly of an ion implanter will be discussed in detail below with respect to FIGS. 9-10. It should be noted that the exemplary methods illustrated herein are described with reference to the exemplary embodiment discussed previously with respect to FIGS. 1-8. However, other embodiments of apparatuses for disk assemblies are not excluded from the scope of the present inventive method.

As illustrated in FIG. 9, the first step, i.e., step S10, may include transfer of the wafer 10 from a wafer cassette 12 positioned inside a load lock chamber to the wafer site 40 by the robotic arm 20. Upon transfer, the robotic arm 20 may hold the wafer 10 above the wafer site 40, such that the wafer 10 may be positioned vertically higher than the fence 42 and in horizontal proximity to the sliding fences 46, e.g., about 2 mm off a center of the wafer site 40 toward the sliding fences 46.

Next, in step S20, the robotic arm 20 may place the wafer 10 onto a plurality of lift pins 62 for support thereof at the position described in step S10. For example, if the disk assembly includes three lift pins 62, the robotic arm 20 may position the wafer 10 above the wafer site 40, such that a center of gravity of the three lift pins 62 may correspond to a center of the wafer 10.

Subsequently, the plurality of lift pins 62 may be lowered through the plurality of lift pin holes 62a in the wafer site 40 to lower the wafer 10 closer to the sliding fences 46 of the disk assembly, i.e., step S30. For example, each lift pin 62 may be lowered at a predetermined speed for a predetermined distance, such that the wafer 10 may be stably lowered to be positioned at an angle on the sliding fences 46. In particular, the wafer 10 may be tilted by the lift pins 62.

Next, upon lowering of the lift pins 62 in step S30, the wafer 10 may slide down via the bevelled side wall 46a of the sliding fence 46 to the pad 48 of the wafer site 40, i.e., step S40, such that one end of the wafer 10 may be in contact with the pad 48. It should be noted, however, that the lift pins 62 may continue supporting the wafer 10. In particular, the wafer 10 may be tilted by the lift pins 62, i.e., one side of the wafer 10 that is in contact with the sliding fence 46 may be higher than the other side that may be in contact with the pad 48, such that one end may be lowered by its weight along the bevelled side wall 46a of the sliding fences 46 to be placed in the wafer site 40 and the other end may sliding horizontally along the pad 48. In this respect, it should be noted that the wafer 10 placement in the wafer site 40 may depend on the slope of the bevelled side wall 46a formed at the sliding fence 46 and the frictional coefficient of the pad 48, i.e., sliding of the wafer 10 into the wafer site 40 may be easier and faster with a steeper slope of the bevelled side wall 46a and a lower frictional coefficient of the pad 48.

Subsequently, the finger 44 may be moved horizontally toward the center of the wafer site 40 to impart a predetermined press power onto the wafer 10 in order to secure the wafer 10 against the fence 42, i.e., step S50. The securing of the wafer 10 by the finger 44 to the fence 42 may prevent the wafer 10 from moving away from the wafer site 40 upon the rotation of the disk 30.

In the sixth step, the WAP sensor 50 may determine whether the wafer 10 is correctly positioned on the pad 48 of the wafer site 40, i.e., step S60. The WAP sensor 50 may determine the distance between the wafer 10 and the pad 48 of the wafer site 40, as described previously with respect to FIGS. 1-4, and output a respective signal to the control unit 70. For example, when the wafer 10 is positioned on the sliding fence 46, the WAP sensor 50 may indicate that the distance between the wafer 10 and the pad 48 is large. However, when the wafer 10 is placed on the pad 48 of the wafer site 40, the WAP sensor 50 may indicate that the distance between the wafer 10 and the pad 48 is small or non-existent.

Consequently, the control unit may determine with respect to the signal received from the WAP sensor 50 whether the wafer 10 is properly secured against the fence 42 of the wafer site 40, i.e., step S70.

In particular, when the control unit 70 determines in step S70 that the wafer 10 is properly secured against the fence 42, i.e., proper loading of the wafer 10 is complete, a signal may be generated to indicate that loading of wafers 10 into the disk 30 may continue, i.e., step S80. The loading process of other wafers 10 may be continued as long as an empty wafer site 40, i.e., wafer site 40 without a wafer 10 thereon, may be placed adjacent to the robotic arm 20 while the disk 30 rotates in one direction.

Alternatively, when the control unit 70 determines in step S70 that the wafer 10 is not properly secured against the fence 42, i.e., loading of the wafer 10 is incomplete, an interlock signal may be generated to indicate that the overall ion implantation process should stop, i.e., step S90. The control unit 70 may output a simultaneous control signal to indicate to an operator a failure in the loading process of the wafers 10 into the disk 30 in order to facilitate fixing of the wafers 10 loading.

Steps S10 through S90 may be repeated sequentially in order to load a plurality of wafers 10 into a disk assembly by the robotic arm 20. One wafer 10 may be loaded into each wafer site 40 of the disk 30 of the disk assembly. After the ion implantation process is complete, the robotic arm 20 and the lift pins 62 may unload treated wafers 10 from the wafer sites 40 into the wafer cassette 12 in reverse order.

The method of loading the wafer 10 by using the disk assembly of the ion implanter in accordance with an embodiment of the present invention may prevent wafer movement and its potential damage due to collision or improper ion implantation. As such, the method may provide increased quality and throughput of wafers.

In accordance with another embodiment of the present invention, another method for loading wafers into a disk assembly of an ion implanter will be discussed in detail below with respect to FIG. 10.

A illustrated in FIG. 10, the first step, i.e., step S100, may include transfer of the wafer 10 from a wafer cassette 12 positioned inside a load lock chamber to the wafer site 40 by the robotic arm 20. Upon transfer, the robotic arm 20 may hold the wafer 10 above the wafer site 40, such that the wafer 10 may be positioned vertically higher than the fence 42 and about 2 mm off a center of the wafer site 40, i.e., about 2 mm away from the fence 42.

Next, in step S200, the robotic arm 20 may place the wafer 10 onto a plurality of lift pins 62 for support thereof at the position described in step S100. For example, if the disk assembly includes three lift pins 62, the robotic arm 20 may position the wafer 10 above the wafer site 40, such that a center of gravity of the three lift pins 62 may correspond to a center of the wafer 10.

Subsequently, the plurality of lift pins 62 may be lowered through the plurality of lift pin holes 62a in the wafer site 40 to lower the wafer 10 closer to the wafer site 40 of the disk assembly, i.e., step S300. For example, each lift pin 62 may be lowered at a predetermined speed for a predetermined distance, such that the wafer 10 may be stably lowered to be positioned at an angle on the pad 48. In particular, the wafer 10 may be tilted by the lifting pins 62, such that a side of the wafer 10 that is in contact with the finger 44 may be higher than the a side that is in contact with the pad 48. In particular, the wafer 10 may be positioned, such that an edge of the wafer 10 that is adjacent to the fence 42 may be supported by the pad 48, while an opposite edge of the wafer 10 that is adjacent to the finger 44 may be supported by the lifting pins 64, such that the wafer 10 may have a predetermined slope. For example, the wafer 10 held on the pad 48 may be titled about 2 mm toward the finger 44.

Subsequently, the finger 44 may be moved horizontally toward the center of the wafer site 40 to impart a predetermined press power onto the wafer 10 in order to secure the wafer 10 against the fence 42, i.e., step S400. The securing of the wafer 10 by the finger 44 to the fence 42 may prevent the wafer 10 from moving away from the wafer site 40 upon the rotation of the disk 30. For example, the wafer 10 positioned on the pad 48 at a distance of about 2 mm from the fence 42 may be secured to the fence 42 by the finger 44. When the wafer 10 is secured against the fence 42, the lifting pins 62 may be lowered, such that an entire surface of the wafer 10 may be positioned horizontally on the pad 48 and be in contact therewith.

In the fifth step, an at least one secured wafer verifying sensor 52 may determine whether the wafer 10 is correctly positioned with respect to the fence 42, i.e., step S500. The at least one secured wafer verifying sensor 52 may determine whether contact between the wafer 10 and the fence 42 exists, as described previously with respect to FIGS. 5-8, and output a respective signal to the control unit 70. For example, when the wafer 10 is in contact with the fence 42, the secured wafer verifying sensor 52 may indicate that the wafer 10 is properly secured against the fence 42.

Consequently, the control unit may determine with respect to the signal received from the secured wafer verifying sensor 52 whether the wafer 10 is properly secured against the fence 42 of the wafer site 40, i.e., step S600.

In particular, when the control unit 70 determines in step S600 that the wafer 10 is properly secured against the fence 42, i.e., proper loading of the wafer 10 is complete, a signal may be generated to indicate that loading of wafers 10 into the disk 30 may continue, i.e., step S700. The loading process of other wafers 10 may be continued as long as an empty wafer site 40, i.e., wafer site 40 without a wafer 10 thereon, may be placed adjacent to the robotic arm 20 while the disk 30 rotates in one direction.

Alternatively, when the control unit 70 determines in step S600 that the wafer 10 is not properly secured against the fence 42, i.e., loading of the wafer 10 is incomplete, an interlock signal may be generated to indicate that the overall ion implantation process should stop, i.e., step S800. Alternatively, the control unit may output a control signal to the finger 44 to secure the wafer 10 against the fence 42. If in response to the control signal to the finger 44 to secure the wafer 10 against the fence 42 the secured wafer verifying sensor 52 still indicates incomplete loading, the control unit may output the interlock control signal to the ion implanter in order to stop the overall process of wafer loading and ion implantation thereof. Simultaneously with the interlock signal, the control unit 70 may output a control signal to indicate to an operator a failure in the loading process of the wafers 10 into the disk 30 in order to facilitate fixing of the wafers 10 loading.

Steps S100 through S800 may be repeated sequentially in order to load a plurality of wafers 10 into a disk assembly by the robotic arm 20. One wafer 10 may be loaded into each wafer site 40 of the disk 30 of the disk assembly. After the ion implantation process is complete, the robotic arm 20 and the lift pins 62 may unload treated wafers 10 from the wafer sites 40 into the wafer cassette 12 in reverse order.

The method of loading wafers 10 using the disk assembly of the ion implanter in accordance with the embodiment described with respect to FIGS. 5-8 may includes determining whether the wafer 10 is secured against the fence 42 by the finger 44. Early determination of incomplete loading may prevent a sticking error caused when the wafer 10 is not secured against the fence 42.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A disk assembly of an ion implanter, comprising:
a disk rotating in one direction;
at least one wafer site positioned on the disk and capable of holding at least one wafer;
at least one fence positioned at an edge of the at least one wafer site;
a finger positioned at the edge of the at least one wafer site and opposite to the fence;
at least one sensor having the capability of determining a position of the wafer relative to the fence; and
a control unit electrically connected to the at least one sensor.

2. The disk assembly as claimed in claim 1, wherein the wafer site comprises a pad to support the wafer.

3. The disk assembly as claimed in claim 1, wherein the wafer site comprises a plurality of lift pin holes, at least one sliding pin hole, and a sensor hole.

4. The disk assembly as claimed in claim 1, further comprising a plurality of sliding fences adjacent to the finger.

5. The disk assembly as claimed in claim 4, wherein at least one sliding fence of the plurality of sliding fences is positioned at each side of the finger along an outer edge of the wafer site.

6. The disk assembly as claimed in claim 5, wherein each sliding fence of the plurality of sliding fences has a beveled side wall.

7. The disk assembly as claimed in claim 4, wherein the fence and the plurality of sliding fences form a shape having a diameter about equal to a diameter of the wafer.

8. The disk assembly as claimed in claim 2, wherein the at least one sensor is a WAP sensor in contact with a center of the wafer site.

9. The disk assembly as claimed in claim 8, wherein the WAP sensor includes a capacitance sensor or a switch sensor.

10. The disk assembly as claimed in claim 1, wherein the at least one sensor is a secured wafer verifying sensor formed in the fence.

11. The disk assembly as claimed in claim 10, wherein the wafer verifying sensor includes a switch sensor.

12. The disk assembly as claimed in claim 1, wherein the at least one sensor includes a plurality of wafer verifying sensors positioned symmetrically in a side wall of the fence relative to a center of the fence.

13. A method of loading a wafer into a disk assembly of an ion implanter, comprising:
placing a wafer onto a wafer site;
securing the wafer on the wafer site against a fence;
operating a sensor to determine a position of the wafer relative to the fence;
transmitting a signal to a controller to indicate the position of the wafer relative to the fence; and
controlling the ion implanter in response to the signal transmitted to the controller.

14. The method as claimed in claim 13, wherein placing the wafer onto the wafer site comprises sliding the wafer onto the wafer site via at least one sliding fence.

15. The method as claimed in claim 13, wherein securing the wafer against the fence comprises moving a finger positioned at the wafer site opposite the fence in a horizontal direction towards the fence.

16. The method as claimed in claim 13, wherein operating a sensor comprises determining a distance between the wafer and the fence.

17. The method as claimed in claim 13, wherein operating a sensor comprises determining a presence of a contact between the wafer and the fence.

18. The method as claimed in claim 13, wherein controlling the ion implanter comprises generating an interlock signal to terminate ion implantation, when the wafer is not secured against the fence.

19. The method as claimed in claim 18, further comprising generating a control signal to indicate a loading failure for an operator.

20. The method as claimed in claim 15, wherein controlling the ion implanter comprises generating a control signal to the finger to secure the wafer against the fence, when the wafer is not secured against the fence.
